(19) United States
(12) Patent Application Publication
(10) Pub. No.: US 2026/0370028 A1
(43) Pub. Date: Nov. 19, 2026

(54) Optimized charging routine for an accumulator

(71) Applicant: Hilti Aktiengesellschaft, Schaan (LI)

(72) Inventors: Moses ENDER, Kaufering (DE); Robert STANGER, Kaufbeuren (DE); Daniel SELTMANN, Türkheim (DE); Rory BRITZ, Starnberg (DE); Markus HARTMANN, Mauerstetten (DE); Klaus HAUSER, Schwabmünchen (DE); Mathias FRENZEL, Unterdießen (DE)

(21) Appl. No.: 19/126,500

(22) PCT Filed: Oct. 23, 2023
(86) PCT No.: PCT/EP2023/079412

§ 371 Date: May 1, 2025

(30) Foreign Application Priority Data
Nov. 8, 2022 (EP) 22206044.4

(51) Int. Cl. H02J 7/90; H02J 7/44; H02J 7/80

(52) U.S. Cl. CPC H02J 7/971; H02J 7/44; H02J 7/80

(57) ABSTRACT

A system containing a charging device and at least one accumulator which can be charged by the charging device and which includes at least one energy storage element, wherein the charging device contains a control unit for controlling a charging process of the accumulator and for setting the charging process to at least one first or second charging setting. In order to detect at least one first and second physical duration, at least one real-time clock is provided which is equipped so as to transmit at least one signal to the control unit in order to set the charging process from a first charging state to a second charging state after at least the first physical duration has expired.

The present invention relates to a system that includes a charging apparatus and at least one accumulator.

Furthermore, the present invention relates to a charging apparatus for use in a system according to the invention.

In addition, the present invention relates to a method for controlling a system that includes a charging apparatus and at least one accumulator.

### BACKGROUND

Accumulators are widely known in the prior art as an energy supply for a power tool. These accumulators include a number of energy storage cells (also referred to as rechargeable cells), which serve and are designed to receive, store, and deliver electrical energy. The receiving of electrical energy into the energy storage cells can also be referred to as charging (or loading). The delivery of electrical energy from the energy storage cells can also be referred to as discharging.

For loading or charging with electrical energy, the accumulator is usually connected to a charging apparatus (also called a charger). The charging apparatus conducts electrical energy in accordance with a predetermined charging setting (also called the charging mode) having defined parameters for the actual charging process at the individual energy storage cells of the accumulator.

### SUMMARY OF THE INVENTION

The charging process starts immediately, regardless of whether internal or external conditions are ideal or even just sufficient (too hot or too cold). Charging as quickly as possible (maximum energy in the shortest possible time) accelerates the ageing process and damages the accumulator permanently.

It is an object of the present invention to solve the problem described above.

The present invention provides a system that includes a charging apparatus and at least one accumulator which can be charged by the charging apparatus and has at least one energy storage element, wherein the charging apparatus includes a control unit for controlling a charging process of the accumulator and for setting the charging process to at least a first or second charging setting.

According to the invention, it is provided that at least one real-time clock is included for detecting at least a first and second physical time period and is designed to send at least one signal to the control unit for setting the charging process from a first charging setting to a second charging setting after at least the first physical time period has elapsed.

In this context, a time period means that an actual time or time of day and the actual date, i.e., a time of day with hours, minutes and seconds as well as a calendar date or weekday, are measured or detected. The real-time clock can be used to measure or detect the actual time, i.e., hours, minutes and seconds. In addition, the real-time clock can measure or detect the actual date, i.e., day, week, month and year.

According to an advantageous exemplary embodiment, it may be possible that at least one photodetector is included for detecting at least one radiation value and sending at least one signal to the control unit depending on the at least one detected radiation value. The expression “detection of at least one radiation value” can mean the brightness or amount of light of or in a space, room or the like. This makes it easy to determine whether it is day or night or whether a room is illuminated by artificial light.

According to a further advantageous exemplary embodiment, it may be possible that at least one acoustic transducer is included for detecting at least one sound value and sending at least one signal to the control unit depending on the at least one detected sound value. This makes it easy to determine whether works or activities are being carried out in the immediate vicinity.

According to an advantageous exemplary embodiment, it may be possible that at least one temperature sensor is included for detecting at least one temperature value and sending at least one signal to the control unit depending on the at least one detected temperature value. This makes it easy to determine whether a room is heated or whether it is night time.

According to a further advantageous exemplary embodiment, it may be possible that at least one acceleration sensor is included for detecting at least one acceleration value and sending at least one signal to the control unit depending on the at least one detected acceleration value. This makes it possible to detect vibrations or shocks caused by steps, works or other activities.

According to an advantageous exemplary embodiment, it may be possible for the charging apparatus to include the at least one photodetector, acoustic transducer, temperature sensor and/or acceleration sensor.

Moreover, the present invention provides a charging apparatus for use in a system according to the invention.

Furthermore, the present invention provides a method for controlling a system that includes a charging apparatus and at least one accumulator which can be charged by the charging apparatus and has at least one energy storage element, wherein the charging apparatus includes a control unit for controlling a charging process of the accumulator and for setting the charging process to at least a first or second charging setting.

According to the invention, the following method steps are involved:
detecting at least one first and second physical time period by at least one real-time clock;
sending at least one signal from the real-time clock to the control unit after at least the first physical time period has elapsed; and
setting the charging process from a first charging setting to a second charging setting.

The first and second physical time periods can be understood as a first and second time. The difference here between the first and second time period can be minutes or hours.

The charging setting can be the amount of electrical energy that is transferred from the charging apparatus to the accumulator during the charging process.

In addition, the charging setting can also be the value of the current intensity and/or current voltage for the charging process.

Furthermore, the charging setting can also be the value of the electrical charge for the charging process that the charging apparatus delivers to the accumulator.

Further advantages can be found in the following description of the figures. A particularly preferred exemplary embodiment of the present invention is illustrated in the figures. The figures, the description, and the claims comprise numerous features in combination. A person skilled in the art will expediently also consider the features individually and combine them to form sensible further combinations.

### BRIEF DESCRIPTION OF THE DRAWINGS

Identical and similar components are denoted by the same reference signs in the figures,
in which:

FIG. 1 shows a side view of a system according to the invention, consisting of a power tool and an accumulator;

FIG. 2 shows a side view of the accumulator; and

FIG. 3 shows a side view of the charging apparatus according to the invention and the accumulator connected to the charging apparatus.

### DETAILED DESCRIPTION

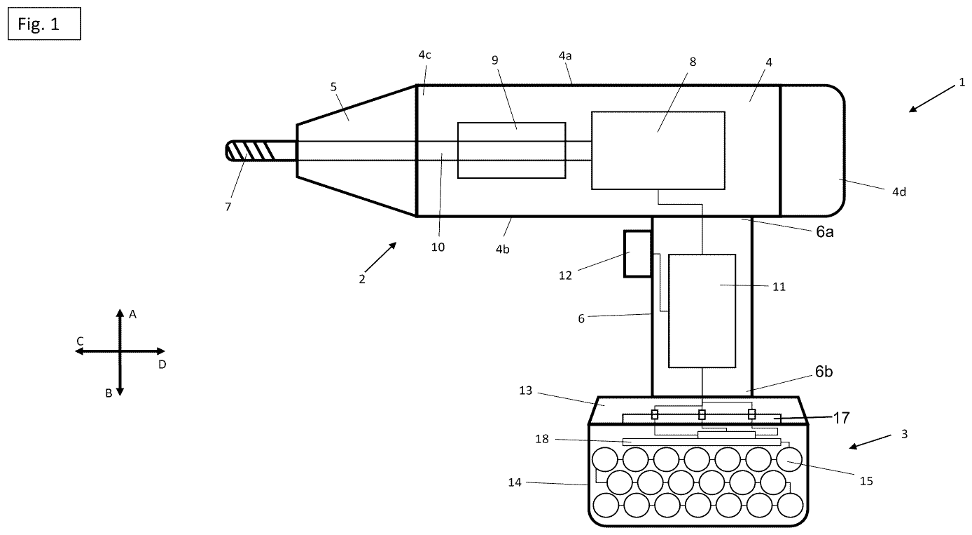

FIG. 1 shows a system 1 formed of a power tool 2 and an accumulator 3 according to an exemplary embodiment. The accumulator 3 is removably connected to the power tool 2 in order to supply the power tool 2 with electrical energy.

The power tool 2 is configured as a power drill in the embodiment shown. Alternatively, the power tool can also be configured as a power drill, a saw, a grinder, or the like.

As indicated in FIG. 1, the power tool 2 configured as a power drill substantially includes a power tool housing 4 with a tool fitting 5 and a handle 6.

The tool fitting 5 serves to receive and retain a tool 7. The tool 7 is a drill bit in the present exemplary embodiment. Alternatively, the tool 7 can also be configured as a screwdriver bit.

A drive 8, a transmission 9, an output shaft 10, and a control unit 11 are, inter alia, provided in the interior of the power tool housing 4.

The drive 8 is configured, for example, as a brushless electric motor and serves to generate torque.

The control unit 11 controls in a closed and open loop the functions and the behavior of the power tool 2 and in particular the drive 8, i.e. the direction of rotation and speed of the drive 8.

The handle 6 in turn includes an actuating switch 12, an upper end 6a, and a lower end 6b. The actuating switch 12 is connected to the control unit such that actuating the actuating switch 12 results in an activation of the drive 8 or the power tool 2.

As also shown in FIG. 1, the drive 8, the transmission 9, the output shaft 10, and the tool fitting 5 are arranged relative to one another such that torque generated by the drive 8 can be transmitted to the tool fitting 5 via the transmission 9 and the output shaft 10. The torque generated by the drive 8 is ultimately transmitted to the tool 7 by the tool fitting 5.

The power tool housing 4 furthermore has an upper side 4a, a lower side 4b, a front end 4c, and a rear end 4d.

The tool fitting 5 is positioned at the front end 4c. The upper end 6a of the handle 6 is fastened to the lower side 4b and in the vicinity of the rear end 4d of the power tool housing 4. A power-tool interface 13 is positioned at the lower end 6b of the handle 6.

The power-tool interface 13 is used for releasably connecting the power tool 2 to the accumulator 3.

According to an alternative exemplary embodiment, the power tool 2 can also be configured such that it is connected to more than one accumulator 3 as an energy source.

The accumulator 3 described in the exemplary embodiment can be used in particular as an energy storage apparatus or electrical energy source for the power tool 2. The accumulator 3 here substantially includes an accumulator housing 14, a number of energy storage cells 15, a storage apparatus 16, an accumulator interface 17, and a control device 18. The energy storage cells 15 can also be referred to as rechargeable cells.

The storage apparatus 16 is positioned in the interior of the accumulator housing 14 and is used to store and provide data and information.

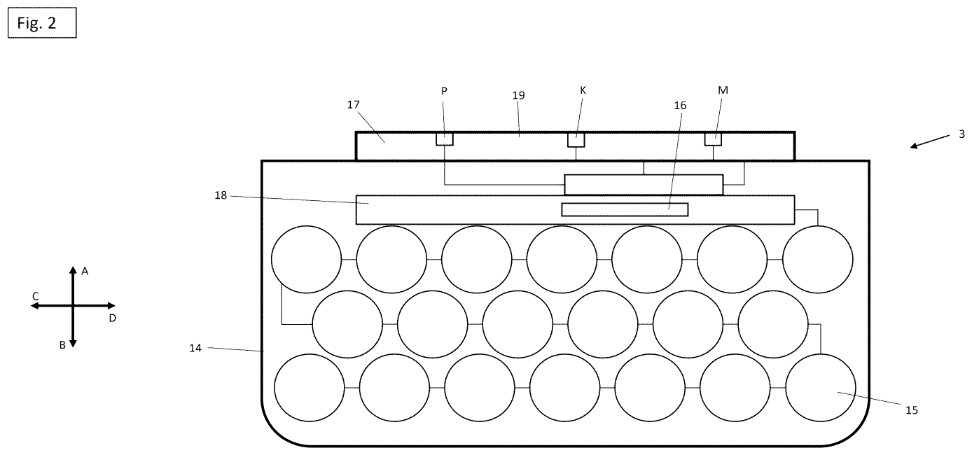

The accumulator interface 17 serves to electrically or electronically connect the accumulator 3 to the power tool 2 by means of the power-tool interface 13. The accumulator interface 17 includes a positive contact P, a negative contact M and a communication contact K for this purpose (see, e.g, FIG. 2).

The positive contact P and negative contact M are used to transfer electrical energy from the energy storage cells 15 of the accumulator 3 to the consumers (in particular the drive) of the machine tool 2.

The communication contact K in turn serves to communicate between the control device 18 of the accumulator 3 and the control unit 11 of the power tool 2. For the communication between the accumulator 3 and the power tool 2, data and information are exchanged in the form of data.

The energy storage cells 15 serve to receive, store and re-deliver electrical energy. As indicated in the Figures, the energy storage cells 15 are cylindrical and configured on the basis of lithium-ion technology.

Alternatively, the energy storage cells 15 can also be based on another suitable technology. The cylindrical shape of the energy storage cells 15 is likewise optional such that any other suitable shape or geometry can also be selected. For example, it is in particular also possible that the energy storage cells 15 are embodied as pouch cells.

To releasably mechanically couple the accumulator 3 to the power tool 2, the system 1 includes a rail apparatus 19.

As indicated in the figures, the rail apparatus 19 is positioned between the accumulator interface 17 and the power-tool interface 13 so that the accumulator 3 can be slid along the rail apparatus 19 and onto the power tool 2 in the arrow direction C and can be removed again (slid off) from the power tool 2 in the arrow direction D. If the accumulator 3 is coupled to the power tool 2 by means of the rail apparatus 19, the positive contact P, the negative contact M, and the communication contact K of the accumulator 3 are in contact with the corresponding positive and negative contacts P, M and the communication contact K of the power tool 2. Electrical energy and electrical signals can then make their way from the accumulator 3 to the power tool 2.

A locking apparatus is used to removably connect the accumulator 3 to the power tool 2.

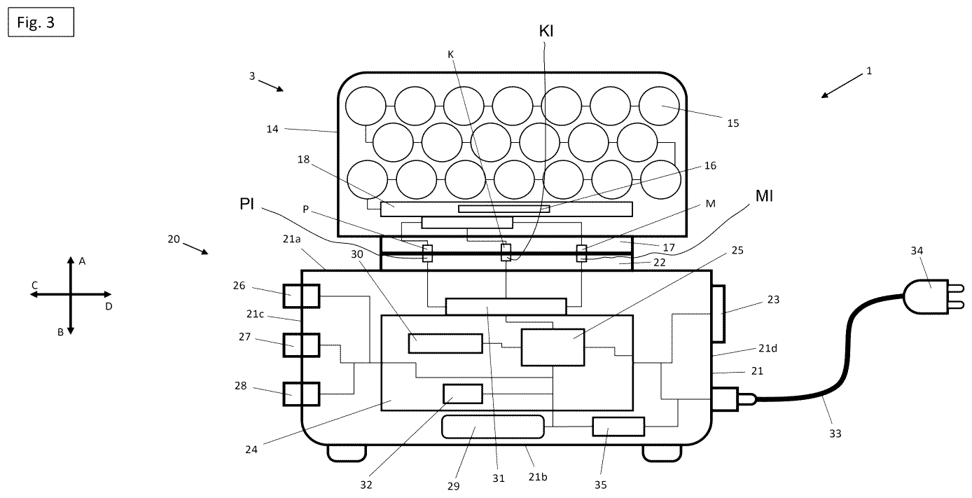

FIG. 3 shows a system 1 with a charging apparatus 20, which is releasably connected to the accumulator 3 for charging the accumulator 3 with electrical energy.

The charging apparatus 20 substantially includes a charger housing 21, a charger interface 22, a control and display device 23, a controller 24, a real-time clock 25, a photodetector 26, an acoustic transducer 27, a temperature sensor 28, a battery 29, a memory 30, a charge measuring device 31 and an acceleration sensor 32.

The charger housing 21 substantially includes an upper side 21a, a lower side 21b, two side walls, a front side 21c and a rear side 21d. The two side walls are not shown in FIG. 3. The controller 24, the real-time clock 25, the battery 29, the memory 30, the charge measuring device 31 and the acceleration sensor 32 are positioned inside the charger housing 21.

The photodetector 26, the acoustic transducer 27 and the temperature sensor 28 are positioned on the front side of the charger housing 21. The photodetector 26 is positioned on the front side 21c of the charger housing 21 in such a way that the ambient light or the brightness of the light in the vicinity of the charging apparatus 20 can be detected.

Furthermore, the acoustic transducer 27 is positioned on the front side 21c of the charger housing 21 in such a way that the sound or noises in the vicinity of the charging apparatus 20 can be detected.

In addition, the temperature sensor 28 is positioned on the front side 21c of the charger housing 21 in such a way that the temperature in the vicinity of the charging apparatus 20 can be detected.

The control and display unit 23 is positioned on the rear side 21d of the charger housing 21 and is used to enter commands or instructions into the controller 24 and to display information.

A first end of a power cable 33 is arranged at the rear 21d of the charger housing 21. A plug 34 is provided at a second end of the power cable 33 and can be releasably connected to a socket. The power cable 33 is used to transport electrical energy from the socket to the charging apparatus 20.

The charging interface 22 is positioned on the upper side 21a of the charger housing 21 and is used for the releasable connection of the charging apparatus 20 to the accumulator interface 17 of the accumulator 3. As indicated in FIG. 3, both the charger interface 22 and the accumulator interface 3 include a positive contact P, a negative contact M and a communication contact K. When the accumulator interface 17 is connected to the charger interface 22, the positive contact P of the accumulator interface 17 is connected to the positive contact PI of the charger interface 22, the negative contact M of the accumulator interface 17 is connected to the negative contact MI of the charger interface 22 and the communication contact K of the accumulator interface 17 is connected to the communication contact KI of the charger interface 22. The positive and negative contacts P, M can be used to transfer electrical energy from the charging apparatus 20 to the accumulator 3. Data and information can be exchanged between the accumulator 3 and the charging apparatus 20 in the form of electrical signals via the communication contacts K. The positive contact P, negative contact M and communication contact K of the accumulator interface 17 are connected to the control unit 18 of the accumulator 3. Accordingly, the positive contact PI, negative contact MI and communication contact KI of the charger interface 22 are connected to the controller 24 of the charging apparatus 20.

The real-time clock 25 is used to detect a physical time period or to detect the current (i.e., local) time and is connected to the controller 24 and the memory 30. The term “local time” means the time at the location of the charging apparatus 20, i.e., for example Central European Time (CET) for a location in Germany. Alternatively, a different time (e.g., Coordinated Universal Time (UTC)) can also be used for the real-time clock 25.

By means of the real-time clock 25, the controller 24 can control the timing of a charging process of the accumulator 3, i.e., charging of an accumulator 3 connected to the charging apparatus 20. In other words: the charging process can be started at certain times, temporarily interrupted, or permanently stopped.

As indicated in FIG. 3, the battery 29 is connected to the real-time clock 25 in such a way that the latter is supplied with electrical energy from the battery 29 when the charging apparatus 20 is not connected to a socket via the power cable 33. The battery 29 is designed as a rechargeable battery (i.e. secondary battery or accumulator). With the help of the battery 29, the real-time clock 25 can remain functional and record the time even if no power is available through the power cable 33.

Furthermore, a charging unit 35 is provided inside the charging housing 21 and is connected to the battery 29 and the power cable 33. The charging unit 35 can be used to charge the battery 29 with electrical energy from the socket via the power cable 33.

In order to carry out the charging process taking into account the real time detected by the real-time clock 25, a charging process of the accumulator 3 is started by the charging apparatus 20 at a first time (for example at 17:00) in accordance with the method according to the invention. After a time period of, for example, 30 minutes has elapsed (i.e., when the real-time clock 25 detects a time of 17:30), the charging process is stopped so that no further electrical energy is supplied from the charging apparatus 20 to the connected accumulator 3. To interrupt the charging process, the real-time clock 25 sends a corresponding signal to the controller 24, as a result of which no further electrical energy is supplied from the charging apparatus 20 to the accumulator 3.

When the real-time clock 25 detects a time of 07:00 (i.e., after 13 hours and 30 minutes after the charging process has been interrupted), the charging process is continued with the accumulator 3 still connected. The charging process can be continued until a predetermined charge quantity is reached. The amount of electrical charge that reaches the accumulator 3 from the charging apparatus 20 is detected by the charge measuring device 31 and transmitted to the controller. Alternatively or additionally to the detection of the charge quantity by the charge measuring device 31, the charge that reaches the accumulator 3 from the charging apparatus 20 during the charging process can also be detected by a measuring apparatus as part of the accumulator 3. The measuring apparatus for detecting a charge quantity as part of the accumulator 3 is not shown in the figures.

The charging process can also be influenced by means of the photodetector 26, acoustic transducer 27, temperature sensor 28 and acceleration sensor 32.

The photodetector 26 detects the light conditions in the vicinity of the charging apparatus 20. If the photodetector 26 detects a brightness value with a certain threshold value, data stored in the memory 30 can be used to determine whether it is dark in the vicinity of the charging apparatus 20. This makes it possible to conclude that it is night and/or that lighting is no longer in use, for example. It is therefore likely that, due to these circumstances, there is no longer a user in the vicinity of the charging apparatus 20 or the accumulator 3 and that the accumulator 3 is not expected to be used in the near future. The charging process can be interrupted due to the expected relatively long period of non-use of the accumulator 3. As soon as a brightness value with a certain threshold value is detected again by the photodetector 26, the charging process can be resumed.

The acoustic transducer 27 detects noises in the vicinity of the charging apparatus 20 and can thus determine whether it is noiseless in the vicinity of the charging apparatus 20. In the case of a noiseless or almost noiseless environment, it can be assumed that there is no longer a user in the vicinity of the charging apparatus 20 or the accumulator 3 and that the accumulator 3 is not expected to be used in the near future. The charging process can be interrupted due to the expected relatively long period of non-use of the accumulator 3. As soon as noises are detected again, the charging process can be resumed.

The temperature sensor 28 detects the temperature in the vicinity of the charging apparatus 20. By comparing the detected temperatures with temperature threshold values stored in the memory 30, it can be determined whether the environment of the charging apparatus 20 is cold. It can therefore be assumed that heating systems in the vicinity of the charging apparatus 20 have been deactivated. This can be done overnight, for example, in order to save energy and costs. Due to an unheated environment, it can be assumed that there is no longer a user in the vicinity of the charging apparatus 20 or the accumulator 3 and that the accumulator 3 is not expected to be used in the near future. The charging process can be interrupted due to the expected relatively long period of non-use of the accumulator 3. As soon as a temperature with a certain threshold value is detected again by the temperature sensor 28, the charging process can be resumed.

The acceleration sensor 32 detects shocks in the form of vibrations or accelerations. If no vibrations or accelerations caused by steps taken by a presumed user of the accumulator 3 or work processes are detected, it can be assumed that there is no longer a user in the vicinity of the charging apparatus 20 or the accumulator 3 and that the accumulator 3 is not expected to be used in the near future. The charging process can be interrupted due to the expected relatively long period of non-use of the accumulator 3. As soon as shocks in the form of vibrations or accelerations are detected again by the acceleration sensor 32, the charging process can be resumed.

### LIST OF REFERENCE SIGNS

1 System
2 Power tool
3 Accumulator
4 Power tool housing
4a Upper side of the power tool housing
4b Lower side of the power tool housing
4c Front end of the power tool housing
4d Rear end of the power tool housing
5 Tool fitting
6 Handle
6a Upper end of the handle
6b Lower end of the handle
7 Tool
8 Drive
9 Transmission
10 Output shaft
11 Control unit
12 Actuating switch
13 Power-tool interface
14 Accumulator housing
15 Energy storage cell
16 Storage device
17 Accumulator interface
18 Control device
19 Rail apparatus
20 Charging apparatus
21 Charger housing
21a Upper side of the charger housing
21b Lower side of the charger housing
21c Front side of the charger housing
21d Rear side of the charger housing
22 Charger interface
23 Control and display apparatus
24 Controller of the charging apparatus
25 Real-time clock
26 Photodetector
27 Acoustic transducer
28 Temperature sensor
29 Battery
30 Memory
31 Charge measuring device
32 Acceleration sensor
33 Power cable
34 Plug
35 Charging unit
P Positive contact
M Negative contact
K Communication contact

What is claimed is:

1-8. (canceled)

9. A system comprising:
a charging apparatus; and
at least one accumulator chargeable by the charging apparatus and having at least one energy storage element,
the charging apparatus including a control unit for controlling a charging process of the accumulator and for setting a charging process to at least a first or second charging setting, at least one real-time clock being contained for detecting at least a first and second physical time period and designed to send at least one signal to the control unit for setting the charging process from the first charging setting to the second charging setting after at least the first physical time period has elapsed.

10. The system as recited in claim 9 further comprising at least one photodetector for detecting at least one radiation value and sending at least one signal to the control unit depending on the at least one detected radiation value.

11. The system as recited in claim 9 further comprising at least one acoustic transducer for detecting at least one sound value and sending at least one signal to the control unit depending on the at least one detected sound value.

12. The system as recited in claim 9 further comprising at least one temperature sensor for detecting at least one temperature value and sending at least one signal to the control unit depending on the at least one detected temperature value.

13. The system as recited in claim 9 further comprising at least one acceleration sensor for detecting at least one acceleration value and sending at least one signal to the control unit depending on the at least one detected acceleration value.

14. The system as recited in claim 9 wherein the charging apparatus includes a photodetector, an acoustic transducer, a temperature sensor or an acceleration sensor.

15. A charging apparatus for use with at least one accumulator chargeable by the charging apparatus and having at least one energy storage element, the charging apparatus comprising:
a control unit for controlling a charging process of the accumulator and for setting a charging process to at least a first or second charging setting, at least one real-time clock being contained for detecting at least a first and second physical time period and designed to send at least one signal to the control unit for setting the charging process from the first charging setting to the second charging setting after at least the first physical time period has elapsed.

16. A method for controlling a system including a charging apparatus and at least one accumulator chargeable by the charging apparatus and having at least one energy storage element, the charging apparatus including a control unit for controlling a charging process of the accumulator and for setting the charging process to at least a first or second charging setting, the method comprising the steps of:
detecting at least one first and second physical time period by way of at least one real-time clock;
sending at least one signal from the real-time clock to the control unit after at least a first physical time period has elapsed; and
setting the charging process from the first charging setting to the second charging setting.
